(19) United States
(12) Patent Application Publication
(10) Pub. No.: US 2013/0118836 A1
(43) Pub. Date: May 16, 2013

(54) ELEVATOR WITH SAFETY DEVICE

(71) Applicant: Inventio AG, Hergiswil NW (CH)

(72) Inventor: Eric Rossignol, Magadino (CH)

(73) Assignee: INVENTIO AG, Hergiswil NW (CH)

(21) Appl. No.: 13/677,745

(22) Filed: Nov. 15, 2012

(30) Foreign Application Priority Data
Nov. 15, 2011 (EP) 11189084.4

(51) Int. Cl. B66B 1/28; B66B 1/32; B66B 5/06

(52) U.S. Cl. CPC B66B 1/28; B66B 5/06; B66B 1/32
USPC 187/247

(57) ABSTRACT

An elevator includes an elevator cage, a drive arrangement, a first safety controller and a second safety controller, wherein the first and the second safety controllers monitor a state of the elevator respectively by means of at least one first or second sensor and on detection of an unsafe state institute a measure in order to bring the elevator into a safe state. The first safety controller is arranged on the elevator cage and the second safety controller is arranged in the region of the drive arrangement.

### CROSS-REFERENCE TO RELATED APPLICATION

This application claims priority to European Patent Application No. 11189084.4, filed on Nov. 15, 2011, which is incorporated herein by reference.

### FIELD

The disclosure relates to an elevator with safety device.

### BACKGROUND

An elevator is usually equipped with a safety chain of contacts and switches connected in series. The contacts or switches monitor the state of a safety-relevant elevator component such as, for example, a story door or a cage door or detect a critical travel situation of the cage such as, for example, excess speed or overrunning of a safety zone at the shaft end. If on occurrence of an unsafe situation one of these switches or contacts in the safety chain is open and thus the safety chain is interrupted, the power feed to the drive is interrupted and the elevator stopped.

This safety device generally has few disadvantages. The individual switches and contacts are based on an electromechanical mode of construction which is subject to a certain degree of wear due to use. With a continuing period of the use this can lead to faulty behavior of the safety device and consequently to increased outlay of maintenance on the installation. In addition, such a safety chain even in the case of flawless functional integrity may not allow any conclusion with respect to the cause of a fault. In practice this leads to in part costly fault-finding work when restoring the elevator to operation after a disturbance.

### SUMMARY

In some embodiments, an elevator comprises a cage, a drive arrangement, an elevator control, a first safety controller and a second safety controller. In that case the first and second safety controllers monitor a state of the elevator respectively by means of at least one first and second sensor. If the first and second safety controllers detect an unsafe state, at least one of the first and second safety controllers institutes a measure in order to bring the elevator into a safe state. The first sensor is arranged on the cage and designed for the purpose of detecting a position and speed of the cage. The second sensor is arranged in the region of the drive arrangement and designed for the purpose of detecting a position and speed of the elevator cage by means of monitoring the rotational movement of a rotor of the drive arrangement. Thus the first and second safety controllers determine the state of the elevator.

In at least some cases, this elevator allows for the multiple detection of the position and speed of the cage by the first and second sensors and the double evaluation of the sensor signals by the first and second safety sensors. This design of the safety device enables use of standard components. Moreover, systems already present in the elevator, such as the first and second sensors which already provide data with respect to the position and speed of the cage for an elevator control, are utilized.

According to a further aspect the first safety controller is arranged on the cage and the second safety controller is arranged in the region of the drive arrangement. In that case, short communication paths arise on the one hand between the first sensor and the first safety controller and on the other hand between the second sensor and the second safety controller.

Still a further aspect relates to detection of the open state of a shaft door by means of a further, third and a further, fourth sensor. The third sensor then communicates with the first safety controller, preferably by way of an associated story panel. The fourth sensor communicates with the second safety controller.

Yet a further aspect relates to detection to an open state of a cage door by means of a further, fifth and a further, sixth sensor. The sixth sensor then communicates with the second safety controller, possibly by way of an associated cage panel.

The fifth sensor communicates with the first safety controller.

In a further aspect the elevator cage comprises a cage brake. The first and/or second safety controller on detection of an unsafe state actuates the cage brake in order to bring the elevator into a safe state. Moreover, the drive arrangement comprises a drive brake. The drive brake is, on detection of an unsafe state, similarly actuated by the first and/or second safety controller in order to bring the elevator into a safe state.

Moreover, an aspect relates to a controller bus which connects the first and the second safety controllers. The first and second safety controllers respectively check, by way of this controller bus, the detected state for equality. In the case of departure from equality of the detected state the first and/or second safety controller brings or bring the elevator into a safe state.

Finally, in a further aspect the elevator comprises an elevator control, wherein the first and second safety controllers communicate a detected state of the elevator to the elevator control.

### BRIEF DESCRIPTION OF THE DRAWING

The disclosed technologies are clarified and further described in the following by way of a drawing, in which:

FIG. 1 shows an embodiment of the elevator with the safety device in a strongly schematic view.

### DETAILED DESCRIPTION

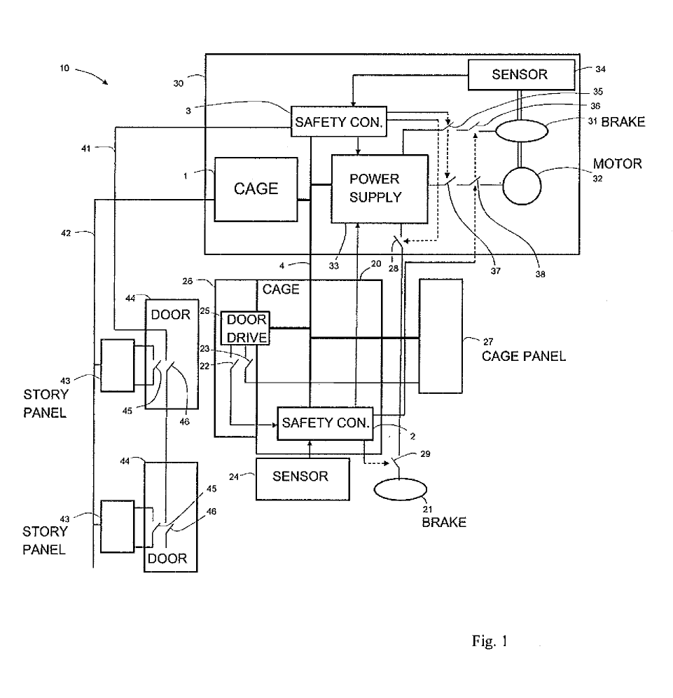

FIG. 1 shows an embodiment of the elevator 10 of a cage 20. The cage 1 is movable along a travel path which is normally defined by guide rails and bounded by a shaft. For that purpose the elevator typically comprises a counterweight, a supporting and drive means at which the cage 20 and the counterweight are suspended, and a drive arrangement 20 with motor 32, which is in operative contact with the supporting and drive means by way of a drive pulley. In order to stop the cage 20 the elevator 10 is additionally equipped with a drive brake 31 which acts on a drive shaft of the motor 32, and with a cage brake 29, which is arranged at the cage 20 and acts on the guide rails. For reasons of clarity the shaft, guide rails, counterweight, supporting and drive means and the drive pulley are not illustrated in FIG. 1.

Moreover, several shaft doors 44 on the stories and a cage door 26 are provided, which doors free the cage 20 for boarding or disembarking at a story stop and shut it again before intended onward travel. Provided for opening and closing the cage door 26 and the shaft doors 44 is a door drive 25 which is arranged on the cage 20.

An elevator control 1 controls the travel of the cage 20. For that purpose the elevator control 1 is connected by way of a line 42, particularly a databus, with story panels 43 each positioned on a story. The story panels 43 represent man/machine interfaces by which a passenger can input a cage call. Depending on the respective design of the story panel 43 different items of information can be communicated to the elevator control 1. At least the location of the actuated story panel is made known to the elevator control 1. In addition, the desired travel direction or even the desired destination story can also be communicated by the cage call.

The elevator 10 is optionally equipped with a cage panel 27 which is positioned in the interior space of the cage 20 and with which the elevator control 1 is connected by way of a further data line. In the illustrated embodiment the data line is designed as a controller bus 4. The cage panel 27 similarly represents a man/machine interface by which a passenger can input his or her destination story to the elevator control 1. In addition, the cage panel 27 can comprise control elements for opening and closing the cage door 26. If the story panels 43 are designed so that the desired destination story is already communicated at the time of the cage call, the control elements for the input of the destination story on the cage panel 27 can be eliminated.

The elevator control 1 evaluates the arriving cage calls and destination story details and plans the journeys of the elevator cage 20 in such a way that the cage calls as well as the desired destination stories are, respectively, served and moved to as efficiently as possible. Accordingly, the elevator control 1 issues control commands to the power supply 33 to supply the motor 32 and the drive brake 31 with power so as to execute the planned journeys of the elevator cage 20. Equally, the elevator control 1 issues control commands to the door drive 25 to open and close again the cage door 26 as well as an associated shaft door 44 at a story stop. These control commands to the power supply 33 and the door drive 25 are possibly carried out by way of the controller bus 4.

In the illustrated embodiment the elevator control 1 is arranged in the region of the drive arrangement 30. However, the elevator control 1 is also positionable in a different region of the elevator 10, for example on the cage 20, in the frame of a shaft door 44 or in the lower region of the shaft.

In order to ensure safe operation of the elevator 10 a safety device is provided which monitors the state of the elevator 1, intervenes on recognition of a critical state and brings the elevator 1 into a safe state. For that purpose the safety device comprises a first safety controller 2 and a second safety controller 3, which are connected by way of the controller bus 4 and communicate by way of this. The two safety controllers 2, 3 monitor, in particular, the position and the speed of the elevator cage 20, the state of the shaft doors 44 and the cage door 26 in each instance by a separate set of sensors 24, 34, 45, 46, 22, 23. In addition, further sensors are also connectible with the safety controllers 2, 3. Such sensors can be designed, for example, for the purpose of realizing a limit switch at the travel path end, monitoring of cable slackness or further safety-relevant functions of the elevator 10.

A first position and speed sensor 24 is arranged on the cage 20 and moves together therewith along the travel path. This sensor 24 is, for example, part of a system which detects an absolute position of the cage 20 with respect to the travel path. Such a system comprises, for example, a magnetic strip which is placed along the travel path and a Hall sensor 24 which is fastened to the cage and which reads off positional data stored on the magnetic strip. Further such systems based on optical, dielectric, etc., codings are known and can be used alternatively to the above example. In departure from strip carriers the coded data can also be applied directly to a guide rail or a wall of the shaft. In addition, the first position and speed sensor 24 can also be realized as an incremental transmitter which runs on a guide surface of a guide rail by means of a friction wheel. The first position and speed sensor 24 is connected with the first safety controller 2 by way of a line and by way of that communicates signals which the first safety controller 2 evaluates.

A second position and speed sensor 34 is disposed in the region of the drive arrangement 30 and monitors the rotational direction and angular speed of the drive shaft of the motor 32. This position and speed sensor 34 is possibly designed as an incremental transmitter. This mode of sensor construction can be reliable and is possibly procurable as a standard product. It is also possible to use other modes of sensor construction by which the position and the speed of the cage 20 are similarly derivable from a movement of the motor. The second position and speed sensor 34 is possibly connected with the second safety controller 3 by way of a further line and by way of that communicates signals which the second safety controller 2 evaluates.

Third and fourth sensors 45, 46 are provided, which each monitor the opening state of an associated shaft door 44. Each shaft door 44 is possibly monitored by such a sensor pair 45, 46. Such sensors 45, 46 are typically designed as electromechanical switches. However, further sensor types are usable in order to monitor the opening state of a shaft door 44. Such alternative sensors are based on, for example, electromagnetic, optical or magnetic modes of functioning. The third sensor 45 is connected with the story panel 43. The signals of the third sensor 45 are communicated by way of a line 42, by which the story panel 43 is connected with the elevator control 1, via an elevator control 1 and controller bus 4 to the first safety controller 2 and also evaluated there. The fourth sensor 46 transmits its signals via a line 41 directly to the second safety controller 3. The second safety controller 3 evaluates the signals of the fourth sensor 46. Possibly, all fourth sensors 46 of different shaft doors 43 are connected in series. Moreover, the lines 42 and 41 are possibly designed as a databus.

Fifth and sixth sensors 22, 23 monitor the opening state of the cage door 26. These sensors 22, 23 are also typically designed as electromechanical switches. Like the third and fourth sensors 45, 46, the fifth and sixth sensors 22, 23 are equally capable of realization by comparable sensors based on alternative modes of functioning. The fifth sensor 22 is directly connected with the first safety controller 2 by way of a line. The first safety controller 2 then evaluates the arriving signals of the fifth sensor 22. The sixth sensor 23 is connected with the cage panel 27. Correspondingly, the signals of the sixth sensor 23 are transmitted by way of the controller bus 4, with which the cage panel 27 is connected, to the second safety controller 3 and evaluated there.

The incoming signals of the sensors 24, 34, 45, 46, 22, 23 are thus evaluated in the respectively associated safety controllers 2, 3. The safety controllers 2, 3 each independently check whether the elevator 10 is in a permissible or impermissible state. The two safety controllers 2, 3 possibly additionally compare the checked sensor signals for equality. If an impermissible state or a departure from equality of the arriving sensor signals is ascertained by at least one of the safety controllers 2, 3 then the at least one safety controller 2, 3 undertakes measures in order to bring the elevator 10 into a safe state.

An unsafe state arises, for example, when a shaft door 43 is open although the cage 20 is not stopped at the corresponding story or when a cage door 26 is not closed during a journey of the cage 20. In addition, the safety controllers 2, 3 can detect excess speed also in dependence on a travel path end or an intended stop.

In order in a given case to be able to bring the elevator 1 back into a safe state, respective switches 37, 38 or 35, 36 or 28, 29 are actuable by the two safety controllers 2, 3. The current feed from the power supply 33 to the motor 32, to an elevator brake 31 or to a cage brake 21 can be interrupted by these switches 37, 38 or 35, 36 or 28, 29. This on the one hand produces switching-off of the motor 32 or engagement of the drive brake 31 or of the cage brake 29. In another embodiment the individual measures are introducible displaced in time. Depending on the effectiveness of a measure the at least one safety controller 2, 3 decides whether a further measure is to be initiated. Thus, for example, the actuation of the switches 37, 38 for initiation of an emergency stop could already transfer the elevator 10 to a safe state. If predeterminable criteria are exceeded, the at least one safety controller 2, 3 decides to additionally activate the drive brake 31 by means of the switches 35, 36 or ultimately to activate the cage brake 21 by means of the switches 28, 29.

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention. Rather, the scope of the invention is defined by the following claims and their equivalents. I therefore claim as my invention all that comes within the scope and spirit of these claims.

I claim:

1. An elevator, comprising:
a cage;
a drive arrangement;
an elevator control;
a first safety controller, the first safety controller being arranged on the cage;
a second safety controller, the second safety controller being arranged near the drive arrangement;
a first sensor, the first sensor being arranged on the cage to detect a position of the cage and a speed of the cage; and
a second sensor, the second sensor being arranged near the drive arrangement to detect a position and speed of the elevator cage by monitoring a rotational movement of a rotor of the drive arrangement, the first and second safety controllers monitoring an elevator state using the first and second sensors, the first and second safety controllers being configured to communicate a detected elevator state to the elevator control.

2. The elevator of claim 1, further comprising:
a third sensor, the third sensor being coupled to the first safety controller and detecting an opening state of a shaft door; and
a fourth sensor, the fourth sensor being coupled to the second safety controller and detecting the opening state of the shaft door.

3. The elevator of claim 2, the third sensor being coupled to the first safety controller through an associated story panel.

4. The elevator of claim 2, further comprising:
a fifth sensor, the fifth sensor being coupled to the first safety controller and detecting an opening state of a cage door; and
a sixth sensor, the sixth sensor being coupled to the second safety controller and detecting the opening state of the cage door.

5. The elevator of claim 4, the sixth sensor being coupled to the second safety controller through an associated cage panel.

6. The elevator of claim 1, further comprising a cage brake, the first safety controller or the second safety controller being configured to actuate the cage brake upon detecting an unsafe state.

7. The elevator of claim 1, further comprising a drive brake, the first safety controller or the second safety controller being configured to actuate the drive brake upon detecting an unsafe state.

8. The elevator of claim 1, further comprising a controller bus connecting the first and second safety controllers, the controller allowing for comparison of signals from the first and second sensors, the first and second safety controllers being configured to bring the elevator into a safe state if the signals from the first and second sensors do not match.
